(19) United States
(12) Patent Application Publication
(10) Pub. No.: US 2008/0114909 A1
(43) Pub. Date: May 15, 2008

(54) DEVICE AND METHOD FOR DETECTION AND PROCESSING OF STALLED DATA REQUEST

(76) Inventor: Kelvin Wong, Chandlers Ford (GB)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/869,303

(22) Filed: Oct. 9, 2007

(30) Foreign Application Priority Data
Nov. 10, 2006 (GB) 0622408.3

(51) Int. Cl. G06F 13/14

(52) U.S. Cl. 710/39

(57) ABSTRACT

A device comprises a communication module connected to an external data link The communication module is arranged to receive a plurality of read and write requests from the data link, and a logic module connected to the communication module. The communication module is arranged to transmit at least some of the plurality of read and write requests to the logic module, the logic module being arranged to process the read and write requests in turn, to detect when the processing of a request is stalled, to execute a decision logic in response to the detection of a stalled request, and to process either the same request or a different request according to the output of the decision logic.

### BACKGROUND OF THE INVENTION

1. Field of the Invention

This invention relates to a device and method for detecting and processing a stalled data request.

2. Background Information

The PCI-Express (PCI-E) specification is a data transfer protocol utilized in many electronic systems. In the language of the protocol, a PCI-E link connects two devices together. If a first device, device A makes a request to read data from or write data to a second device, device B then device A is known as the requester and device B the completer. Device B fulfils the request made to it by device A. FIG. 1 illustrates a generic architecture 10 that may be used for the completer logic of a PCI-E ASIC. The architecture 10 includes the following two major components, a PCI-E communication module 12 and a Completion Logic Module 14.

The PCI-E communication module 12 implements the PCI-E protocol for the ASIC 10. This module 12 receives read and write requests from an upstream requester via a PCI-E link 16. These requests are forwarded to the Completion Logic Module (CLM 14) using one of two interfaces (one passing write requests, the other read requests). The ASIC 10 can receive multiple outstanding read requests (this number denoted by r) and multiple outstanding write requests (this number denoted by w). The maximum values of r and w depend on the amount of buffer space the ASIC possesses for holding data for requests and these values are device dependent.

The PCI-E module 12 will send requests to the logic module 14 in the order they are received from the PCI-E link 16. The module 12 may send multiple read requests to the CLM 14 at a time (up to r) but will only send one write request at a time, according to the terms of the PCI specification. Any data requests arriving behind this write request (whether read or write) will not be passed to the CLM 14 until the outstanding write request has been completed. As an example, if the following requests arrive in the following order,

Read1, Read2, Write1, Read3, Write2, Read4,

then data requests Read1, Read2 and Write1 will be passed to the CLM 14. However, Read3 and Write2 will only be passed to the CLM 14 once Write1 has been completed. Read4 will only be passed to the arbiter once Write2 has been completed. This ensures that the following PCI-E transaction ordering rules are not broken; firstly that sprite requests are completed in strict order of receipt, and secondly, that read requests do not overtake write requests. The PCI-E module 12 sends write requests to the logic module 14 over a generic interface consisting of a Write Address Bus (to CLM 14), a Write Transfer Count bus (to CLM 14), a Write Request signal (to CLM 14) which when asserted indicates that the Write Address Bus and Write Transfer Count bus are valid, a Write Completion FIFO buffer 18 (to CLM 14) which is where data for a write request is stored by the PCI-E module 12 while the request waits to be transferred by the CLM 14, and a Write Done signal (from CLM 14) which indicates that all the data for a write request has been transferred.

The PCI-E module 12 sends read requests to the logic module 14 over a generic interface consisting of a Read Address Bus (to CLM 14), a Read Transfer Count bus (to CLM 14), a Read Request Tag bus (to CLM 14) which carries an identifier associated with the read request (when the CLM 14 fetches data and passes it to the PCI-E module 12, it attaches this tag so that the PCI-E module 12 knows which read request the data has been fetched for), a Read Request signal (to CLM 14), which when asserted indicates that the Read Address Bus, Read Transfer Count bus and Read Tag bus are valid, a Read Completion FIFO buffer 20 (from CLM 14) which is where data for read requests is stored by the CLM 14 while it is waiting to be transferred on the PCI-E link 16 by the PCI-E module 12, a Read FIFO space count (to CLM 14) which indicates how much free space is currently available in the Read Completion FIFO 20 for the CLM 14 to place new data (this count decreases when data is inserted by the CLM 14 and increases when data is extracted by the PCI-E module 12), a Read Done signal (from CLM 14) which when asserted indicates the read on a Read Complete Tag bus is completed, and a Read Complete Tag bus (from CLM 14) which will carry the value of the identifier associated with the completed read request. This identifier seas originally passed to the CLM 14 via the Read Request Tag bus.

The completion logic module 14 fulfils the requests for data transfer it receives from the PCI-E module 12. The requests received can be done in any order and can be interleaved i.e. a portion (but not all) of the total byte count for one particular request may be transferred and then a portion of a completely different request may be transferred. If read requests are interleaved in this manner the PCI-E protocol does impose a restriction. If the CLM 14 transfers a portion (but not all) of the requested data for one read and then switches to servicing a second read, the end PCI address of the data portion delivered for the first read must coincide with a Read Completion Boundary. This is defined as a 128-byte aligned address for endpoints and 64-byte aligned address for root complexes.

The CLM 14 also has an interface to the rest of the ASIC. This interface would be based on a known ASIC inter-connect protocol which allows data transfer between the CLM 14 and different components 22 of the ASIC 10. Examples of such a protocol could be a point-to-point architecture, a shared bus architecture or a protocol such as that described in U.S. Pat. No. 6,467,001 “VLSI Chip Macro Interface”. Read and write requests from the PCI-E module 12 are essentially requests to transfer data from and to different components of the ASIC.

For a write request, the CLM 14 extracts the data from the Write Completion FIFO 18 and sends it out via the inter-connect protocol to the intended component of the ASIC. For a read request, the CLM 14 uses the inter-connect protocol to fetch data from the intended component of the ASIC and places that data into the Read Completion FIFO 20. The data is extracted by the PCI-E module 12, formatted into read completion packets and sent out on the PCI-E link 16. The completion FIFO buffers 18 and 20 act as buffers compensating for the bandwidth differential between the inter-connect protocol and the PCI-E link 16.

The CLM 14 performs requests in the order they are issued by the PCI-E module 12. The drawback to this method is that it provides inefficient bandwidth utilization of the PCI-E link 16 and thus reduces overall system performance. For example, suppose the CLM 14 is given a read request followed by a write request. The CLM 14 would perform the read first. Part way through the transfer, the component from which the data is being fetched experiences a delay. In this situation, the component would instruct the CLM 14, via the inter-connect protocol, to break of and return later for the remainder of the data, that is to “retry” the transfer later on. Since the CLM 14 is performing the requests in order it will straight away attempt to resume the read transfer. It may be a while before the remaining data can be provided. All the while the write request is being stalled behind the read.

Thus the drawback with the known operation of the PCI protocol is that if one request becomes stalled, this stalled request will hold up data requests which arrived behind the stalled request. Less data transfer can occur on the PCI-E link 16 as the number of incoming requests backs up, leading to a reduction in PCI-E bandwidth utilization.

### SUMMARY OF THE INVENTION

According to a first aspect of the invention, there is provided a device comprising a commination module connected to an external data link, the communication module arranged to receive a plurality of read and write requests from the data link, and a logic module connected to the communication module, the communication module arranged to transmit at least some of the plurality of read and write requests to the logic module, the logic module arranged to process the read and write requests in turn, to detect when the processing of a request is stalled, to execute a decision logic in response to the detection of a stalled request, and to process either the same request or a different request according to the output of the decision logic.

According to a second aspect of the invention, there is provided a method comprising receiving a plurality of read and write requests at a communication module from a data link, transmitting at least some of the plurality of read and write requests from the communication module to a logic module, processing the read and write requests in turn at the logic module, detecting when the processing of a request is stalled, executing a decision logic in response to the detection of a stalled request, and processing either the same request or a different request according to the output of the decision logic.

One general embodiment of the invention comprises a method for the way in which a logic module decides which data requests to perform. The logic module is monitoring the performance of the processing of the data requests. When it is detected that a request has stalled, then the logic module has the option to switch to a different request and process that different request before returning to complete the stalled request. In many situations, this will lead to an improved handling of the data requests received by the device, thereby resulting in a taster and more efficient device.

In an embodiment based upon the PCI-E protocol, a set of registers is initialized whenever a new request arrives from the communication module. This register set stores the initial count and address of a data request. As data is transferred for the request these registers update thus tracking the progress of the request.

In one embodiment, a state machine monitors these registers. If a data transfer stops, so that processing of a request is stalled, without all the requested data being transferred, the state machine decides whether it needs to persevere with the current request (because not doing so would violate the PCI-E protocol) or to switch to another outstanding request. The method described here would be implemented in the completion logic module, in a PCI express embodiment. The modified device describes a method for deciding which outstanding data request should be attempted by the logic module, at any given moment of operation.

Switching to another request, if possible, rather than single-mindedly sticking with the same request means that even though one data request may be stalled, data for another request can still be moved. This means that there is more chance that the data flow paths within the device and on the data link itself get utilized more often. The improved bandwidth utilization this implies improves the overall performance of the whole data transfer system.

Advantageously, the logic module is arranged, when executing the decision logic in response to the detection of a stalled read request, to access a minimum packet size and to output a decision to process the same read request if data acquired prior to the stalling is below the minimum packet size. When deciding whether to retry the same data read request or switch to a new request, the logic module can take into account the amount of data that has been already acquired, prior to the stalling of the request. If the amount that has been read is below a predefined specific size, then this can used as a trigger to continue with that request, in order to maintain efficiency of operation.

The logic module is arranged, when executing the decision logic in response to the detection of a stalled read request, to access a predefined message size and to output a decision to process the same read request if data acquired prior to the stalling is not an integer multiple of the predefined message size. Similarly to the decision making above, the logic module can use the amount of data that has been already acquired, prior to the stalling of the request, to check to see if that acquired data is a multiple of the packet size. Again, this can used as a trigger to continue with that read request, in order to maintain operational efficiency.

### BRIEF DESCRIPTION OF THE DRAWINGS

Embodiments of the present invention will now be described, by way of example only, with reference to the accompanying drawings, in which:

FIG. 1 is a schematic diagram of a generic architecture data transfer,

FIG. 2 is a schematic diagram of write registers of the device of FIG. 1;

FIG. 3 is a schematic diagram of read registers of the device of FIG. 1;

FIG. 4 is a flow diagram of a method of operating the device of FIG. 1;

FIG. 5 is a schematic diagram of components, including a state machine, of a logic module; and

FIG. 6 is a schematic diagram of the state machine of FIG. 5.

### DESCRIPTION OF THE PREFERRED EMBODIMENTS

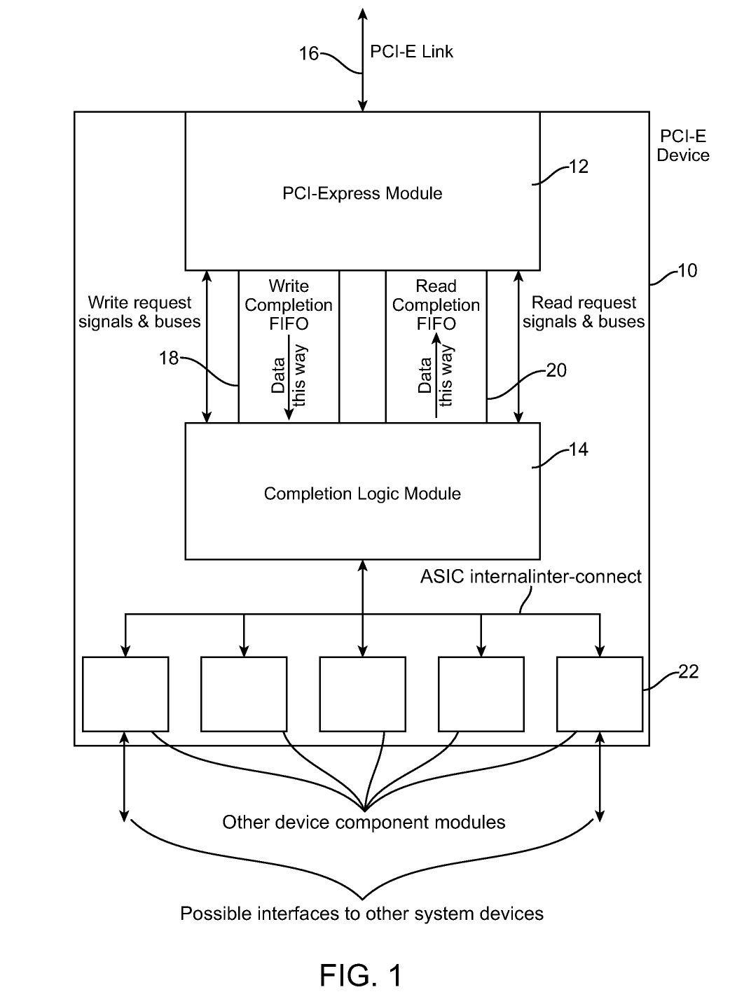

FIG. 1 shows a device 10 comprising a communication module 12 and a logic module 14. The communication module 12 is connected to an external data link 16 and arranged to receive a plurality of read and write requests from the data link 16. The logic module 14 is connected to the communication module 12. The communication module 12 is arranged to transmit at least some of the plurality of read and write requests it receives to the logic module 14.

The logic module 14 is arranged to process the read and write requests in turn, to detect when the processing of a request is stalled, to execute a decision logic in response to the detection of a stalled request, and to process either the same request or a different request according to the output of the decision logic. The logic module 14 includes a state machine (discussed in more detail below). The state machine is arranged to execute the decision logic in response to the detection of a stalled request. The device 10 also comprises first and second buffers 18 and 20. The first buffer 18 arranged to store the write requests and the second buffer 20 arranged to store the read requests.

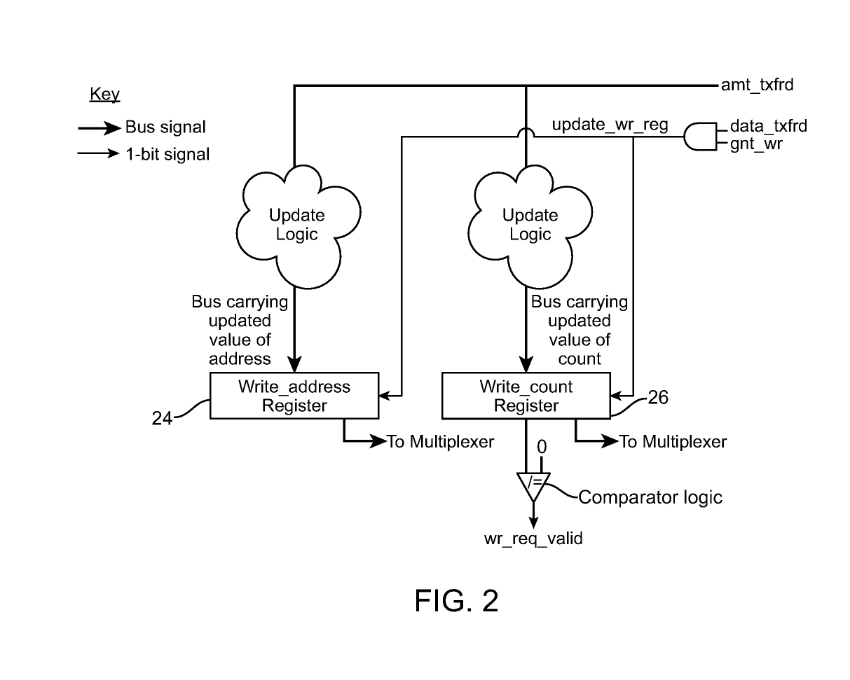

In an embodiment that uses PCI, then the communication module 12 is a PCI-E module and the logic module 14 is a completion logic module (CLM). In this embodiment, when the PCI-E module 12 sends a write request to the CLM 14, the address and count are stored in registers write_address and write_count respectively, shown in FIG. 2 as registers 24 and 26. A signal called write_request_valid is derived from write_count in the following way:

write_request_valid=(write_count=0)

i.e. write_request_valid is asserted when write_count is non-zero

FIG. 2 shows the set up of the write request registers 24 and 26. The registers 24 and 26 are updated on any cycle when write data is extracted from the Write Completion FIFO 18 and sent out on an inter-connect to a component 22. The amt_txfrd bus and data_txfrd signal are standard signals derived from within the CLM 14. When data_txfrd is asserted (TRUE) then in that particular cycle amt_txfrd bytes was transferred between the Completion FIFO 18 and the designated inter-connect (in the case of a write, from the FIFO 18 to the inter-connect). Data_txfrd is ANDed with a signal called gnt_wr which indicates that a write operation is currently being performed. The result of this AND operation is a signal called update_wr_reg. When update_wr_reg is asserted the address register is incremented by the value of amt_txfrd and the count register is decremented by amt_txfrd.

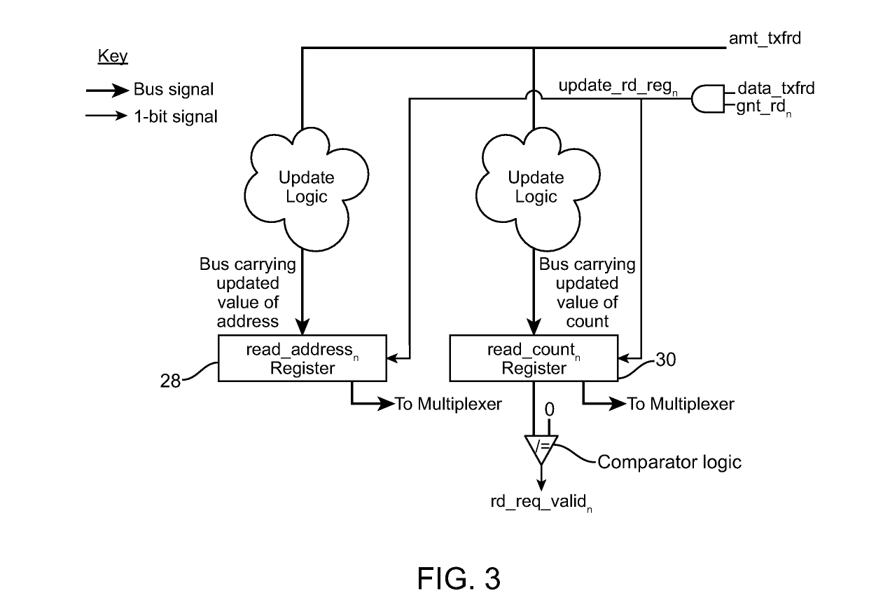

Similarly, as shown in FIG. 3, there are n pairs of registers 28 and 30 read_addressₙ and read_countₙ (where 0<=n<r) to store addresses and Counts for up to r outstanding read requests. When the Read Request signal is asserted with a value of n on the Read Request Tag bus, the address and count for that request is loaded into read_addressₙ and read_countₙ respectively. There is a signal read_request_validₙ derived from read_countₙ in the following way;

read_request_validₙ=(read_countₙ/=0)

FIG. 3 shows the set up for the nth pair of read request registers. This time the registers are updated (address incremented by amt_txfrd, count decremented by amt_txfrd) when a signal called update_rd_regₙ is asserted. This signal is an AND of data_txfrd and gnt_rdₙ. Gnt_rdₙ indicates that the read request associated with tag n is currently active. The logic module 14 has a single set of write registers and n sets of read registers, as the logic module 14 will receive from the communication module 12 a single write request and multiple read requests. The communication module 12 is also arranged, following receipt of data from the logic module 14 indicating that a write request has been processed, to transmit a further plurality of read and single write request to the logic module 14.

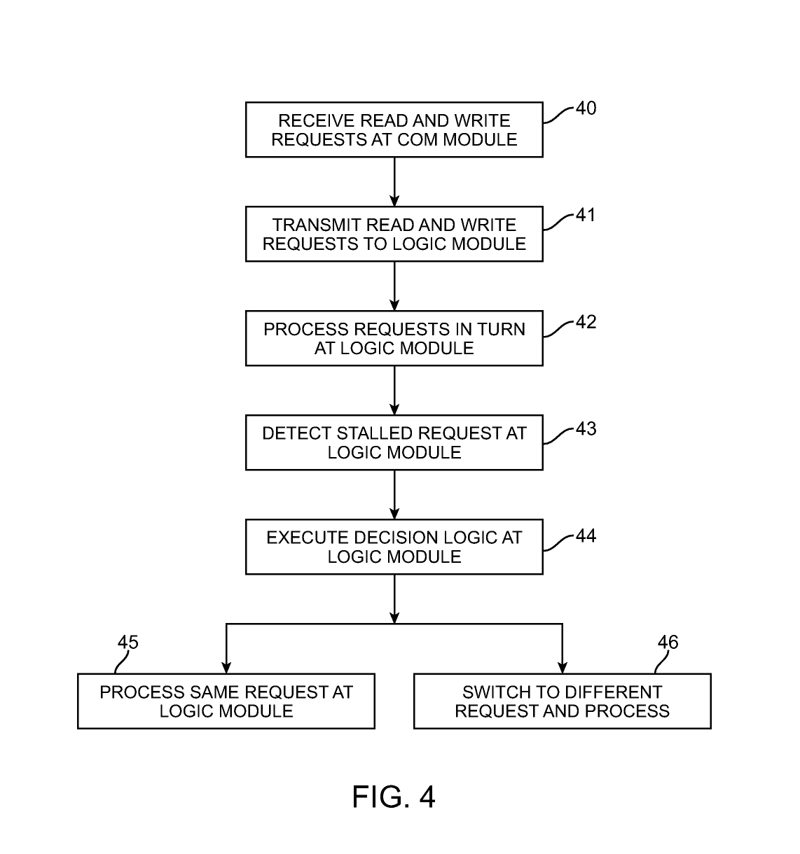

FIG. 4 summarizes the method employed by the device 10 which comprises receiving (step 40) a plurality of read and write requests at the communication module 12 from the data link 16, transmitting (step 41) at least some of the plurality of read and write requests from the communication 12 module to the logic module 14, processing (step 42) the read and write requests in turn at the logic module 14, detecting (step 43) when the processing of a request is stalled, executing (step 44) a decision logic in response to the detection of a stalled request, and processing either the same request (step 45) or a different request (step 46) according to the output of the decision logic.

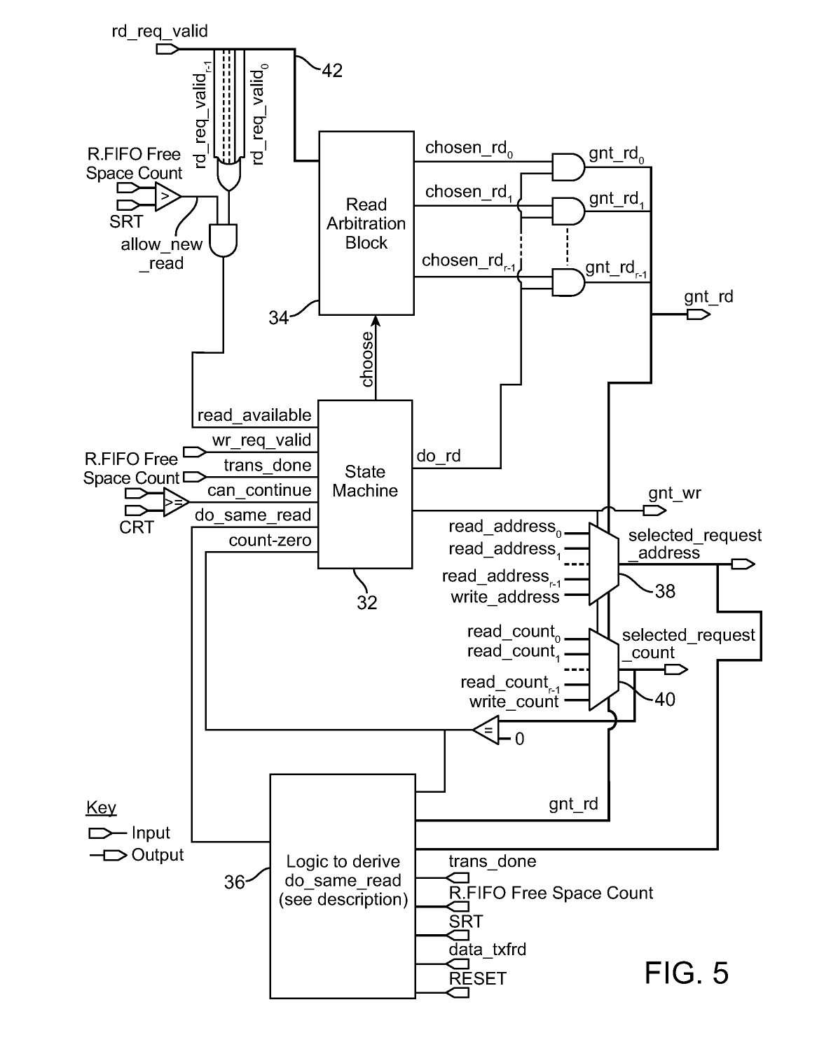

The decision logic within the logic module 14 is shown in detail in FIG. 5, which comprises the principal components of a state machine 32, a read arbitration block 34, and a logic component 36. The outputs of the decision logic are:
gnt_rd—an r-bit one hot bus. When gnt_rdₙ (0<=n<r) is active then this indicates to the rest of the logic module 14 that the outstanding read request associated with tag n is to be processed.
gnt_wr—signal indicating to the rest of the logic module 14 that the outstanding write request is to be processed.
selected_request_address—This is derived from a multiplexer 38 for which all the address registers are inputs and the gnt_rd bus and gnt_wr are the multiplexer selects. Thus when gnt_wr is active, selected_request_address takes the value of write_address. When gnt_rdₙ is active, selected_request_address takes the value of read_addressn.
selected_request_count—This is derived from a second multiplexer 40, where the gnt_rd bus and gnt_wr form the selects. The count registers are the inputs from which one is selected.

These outputs are fed to the rest of the logic module 14 to instruct the module 14 to carry out the chosen request starting at selected_request_address and to transfer selected_request_count bytes in total. The gnt_rd bus and gnt_wr signal indicates in which direction the data is transferred.

An r bit read_request_valid bus 42 is fed into the arbitration block 34 which outputs an r-bit one-hot bus called chosen_rd. When the input choose is asserted (from the state machine 32) this arbitration block 34 will select one of the active read_request_valid bits and assert the corresponding chosen_rd bit which will remain active until the next clock cycle. The chosen input is asserted at which point another active read-request_valid_bit (if any) will be picked.

The state machine 32 determines whether a read or a write request should be processed write_request_valid is fed directly to the state machine 32. All bits on the read_request_valid bus are ORed together and the result ANDed with another signal called allow_new_read to form read_available. This is then input into the state machine 32.
allow_new_read is derived by comparing the value of the Read FIFO Space Count with a programmable value called Start Read Threshold (SRT). Only if the space count is greater than SRT will allow_read be asserted, allowing the state machine 32 to consider starting a new read request. Therefore, varying the SRT varies the point at which the logic module 14 will begin a new read.

The higher the value of SRT, the more space there needs to be in the FIFO before a read is started. More space means that more new data can be accepted into the FIFO leading to a larger burst transaction on the inter-connect, possibly increasing inter-connect utilisation and performance. However, the higher the value of SRT the longer the communication module 12 must wait before more read data is forthcoming. If the logic module 14 waits too long to start a read (i.e. too high a value of SRT is used) the commination module 12 could empty the FIFO completely before new data arrives. Thus the module 12 has no more read data to send which could affect the PCI-E link utilisation. The optimum value of SRT is dependent upon the system. Making it programmable allows system performance to be tuned.

There are four other state machine inputs:
trans_done—a signal derived from another part of the logic module 14. This signal indicates that the transaction on the inter-connect has terminated. For a write, this signal is asserted once all data for that particular burst has been sent on the inter-connect. For a read, it is asserted once all data received from that burst has been put in the Read Completion FIFO.
count_zero—signal which is asserted when selected_request_count=0. If selected_request_count is non-zero then this signal is deasserted. When trans_done=1 when this signal is asserted it will mean that all data for the request has been transferred.
do_same_read—signal instructing the state machine 3) that it must choose the same read request (or do a write request if any), but it must not switch and choose a different read request. This may be, for example, that choosing a different read request would violate the operating protocol (such as PCI-E) with regards to read completion boundaries.
can_continue—signal which is asserted when the Read FIFO Space count exceeds a programmable value called Continue Read Threshold (CRT). Varying CRT controls how empty the read FIFO has to be before retrying the read. The higher the value of CRT, the emptier the FIFO must be and thus the more data can be fit into the FIFO once the read transaction continues on the inter-connect. This allows the inter-connect bandwidth utilisation to be tuned by the system. CRT must be set at a lower value than SRT for the device 10 to work properly.

do_same_read is derived as follows: Each read request has a set-reset latch associated with it such that got_first_dataₙ, is the latch associated with the read request possessing tag n (0<=n<r). got_first_dataₙ, is set when gnt_rdₙ, AND data_txfrd, and is reset when RESET or (gntx and trans_done and count_zero), where RESET is the overall system reset signal.

The signal gfd is then derived as follows:
[Existential quantification of got_first data, and gnt_rdₙ, for 0<=n<r] Do_same_read can now be defined by the following pseudo code:
If (selected_request_address is not on an RCB and gfd=1) or Read FIFO free space count<SRT then do_same_read=1 else do_same_read=0. This will cause the state machine 32 to pick the same read that it is currently doing and no other read because of one of two reasons:

1. The last burst for current read did not finish on an RCB providing some data has already been transferred for that read request. If no data has been transferred then, the request has not been started vet and so no violation of the RCB rule can have occurred, or

2. The amount of space in the Read Completion FIFO is less than SRT, the threshold used to determine whether to start a new read. Tuning the value of SRT allows the logic module 14 to determine how long to persist in trying to fulfil the current read request before switching over to another read request. It may be that persisting for just a little while may yield the remaining data soon. The reason for doing this is that the more contiguous data that can be delivered into the FIFO for an individual request the larger the resulting completion packet on the data link 16. One packet containing x bytes of data in its payload has a better bandwidth utilisation than multiple packets delivering x bytes of data in total. This is due to the fact that each packet must include a header, when transmitted. More bandwidth used transmitting headers means less bandwidth available for transmitting useful data. Obviously persisting too long with a read request will hold up others. Thus the value of SRT is programmable to allow performance tuning for the applied device. If a request is indeed stalled, then with no new data being stored in the FIFO, the free space count will eventually exceed SRT, and provided the RCB restriction is not violated, do_same_read will be asserted and another read request can be chosen.

The state machine has three outputs:
choose—signal which tells the arbitration block 34 to select one of the outstanding read requests.
do_read—signal which indicates that a read request has been chosen.
gnt_wr—signal which indicates that the write request has been chosen.
Each bit on the chosen_rd bus is ANDed with the do_read state machine output to form gnt_rd as follows: gnt_rdₙ=do_read AND chosen_rdₙ

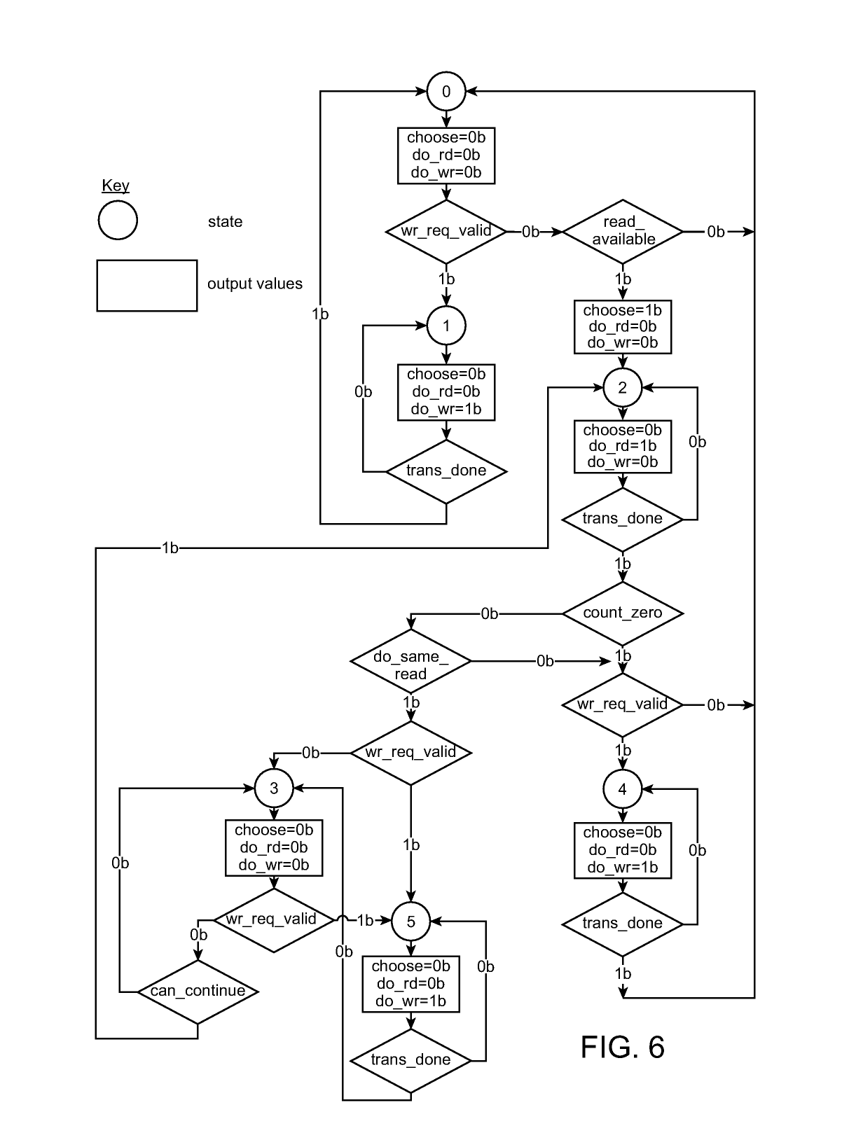

FIG. 6 shows how the state machine 32 is implemented. The flow diagram of FIG. 6 is analogous to a real piece of logic which is synchronised to a clock. At the start of each clock cycle, the state machine 32 will be on one of the circles (with each circle representing a state within the state machine 32). Within that clock cycle, the logic automatically moves through the rectangles and the diamonds of the flow diagram until another circle (state) is reached. The rectangles in the diagram represent setting the state machine's outputs and the diamonds represent decisions. The boxes between any two states represent the actions and decisions made when in a particular cycle. When the logic is about to reach another circle, that is the point where nothing further happens during that clock cycle. On the next clock cycle, the logic starts from that other circle i.e. from the next state.

At the start of processing it is assumed that the state machine 32 will begin from state 0. In the first clock cycle, the actions taken by the state machine 32 will be to instantly move along to the rectangle which sets choose=0b, do_rd=0b and do_wr=0b. Then the processing instantly moves to the wr_req_valid diamond and samples its value, If wr_req_valid=1b (TRUE) then this will take the logic to state 1 on the next clock cycle. In other words in one clock cycle the logic moves from the circle 0 to the rectangle to the diamond and that is all of the processing for that clock cycle. The movement from circle to rectangle to diamond represents the actions taken by the state machine 32 when it is in state 0. On the next clock cycle the processing will start again on circle 1 i.e. the state machine 32 starts processing from state 1.

From state 0, the state machine 32 checks wr_req_valid to see if a write request must be processed (which happens when a write request is the oldest data request). If there is a write request to be processed, then the state machine 32 cycles round state 1 until that write request is complete. It then returns to state 0.

From state 0, if wr_req_valid=0b (FALSE) i.e. there are no write requests and if there are one or more read requests that can be processed, then choose=1b (as an output of state machine 32) causing the read arbitration block 34 to select a read request. The state machine 32 will then pass to state 2, and will cycle round state 2 until trans_done=1b. This will happen when it is identified that no more data is currently being transferred. This may be because the processing of the read request is stalled, and count_zero is used to check whether the individual read request has actually completed or is stalled. Since a valid read request comprises a data address plus an amount of data to be delivered (the count), and the count is reduced as data is acquired for that read request, if the count is zero (count_zero is TRUE) then that specific request has been completed, and is not stalled. In this case, then the state machine 32 will move to state 4, which mimics state 1.

However if count_zero is FALSE, indicating that the read request is stalled, then the logic checks do_same_read. This relates to factors such as whether enough data has been acquired to justify sending a packet, or whether the data read has ended at an address coincident with an RCB. If do_same_read is TRUE, meaning that the same read must be processed, then the logic moves onto either state 3 or state 5, depending upon whether there is a write request to be processed. If it is not essential to process the same read, do_same_read being FALSE, then the logic will route back ultimately to state 0, and as the logic approaches state 2, choose=1b (as an output of the state machine 32) meaning that another read request is chosen, by the read arbitration block 34.

From state 3, the state machine 32 samples wr_req_valid. If wr_req_valid is TRUE then, on the next cycle, it moves to state 5 when a write request is processed. The state machine 32 will cycle round state 5 until trans_done=1b. At this point either the write has stalled or has completed i.e. its data count has reached zero. Either way the state machine 32 returns to state 3 on the next clock cycle.

From state 3, if wr_req_valid is FALSE then the state machine 32 samples the signal can_continue. This relates to whether the former stalled read request can be restarted based on the amount of space in the Read Completion FIFO buffer 20. If can_continue is FALSE then the state machine 32 returns to state 3 on the next clock cycle. If, however, can_continue is TRUE the state machine 32 returns to state 2 to continue the former stalled read request. In this way, state machine 32 embodies the logic of checking for stalling in a data request, and in response to this, deciding either to retry that request or to choose another request to process.

What is claimed is:

1. A device comprising a communication module connected to an external data link, the communication module arranged to receive a plurality of read and write requests from the data link, and a logic module connected to the communication module, the communication module arranged to transmit at least some of the plurality of read and write requests to the logic module, the logic module arranged to process the read and write requests in turn, to detect when the processing of a request is stalled, to execute a decision logic in response to the detection of a stalled request, and to process either the same request or a different request according to the output of the decision logic.

2. A device according to claim 1, wherein the logic module includes a state machine, the state machine arranged to execute the decision logic in response to the detection of a stalled request.

3. A device according to claim 2, wherein the communication module is arranged, when transmitting at least some of the plurality of read and write requests to the logic module, to transmit a plurality of read requests and a single write request to the logic module.

4. A device according to claim 3, wherein the communication module is further arranged, following receipt of data from the logic module indicating that a write request has been processed, to transmit a further plurality of read and write requests to the logic module.

5. A device according to claim 4, further comprising:
first and second buffers, the first buffer arranged to store the write requests and the second buffer arranged to store the read requests.

6. A device according to claim 5, wherein the logic module is arranged, when executing the decision logic in response to the detection of a stalled read request, to access a minimum packet size and to output a decision to process the same read request if data acquired prior to the stalling is below the minimum packet size.

7. A device according to claim 6, wherein the logic module is arranged, when executing the decision logic in response to the detection of a stalled read request, to access a predefined message size and to output a decision to process the same read request if data acquired prior to the stalling is not an integer multiple of the predefined message size.

8. A method comprising:
receiving a plurality of read and write requests at a communication module from a data link, transmitting at least some of the plurality of read and write requests from the communication module to a logic module;
processing the read and write requests in turn at the logic module, detecting when the processing of a request is stalled;
executing a decision logic in response to the detection of a stalled request; and
processing either the same request or a different request according to the output of the decision logic.

9. A method according to claim X, wherein the executing of the decision logic, in response to the detection of a stalled request logic module is carried out by a state machine.

10. A method according to claim 9, wherein the step of transmitting at least some of the plurality of read and write requests to the logic module comprises transmitting a plurality of read requests and a single write request to the logic module.

11. A method according to claim 10, further comprising:
receiving data indicating that a write request has been processed and transmitting a further plurality of read and write requests from the communication module to the logic module.

12. A method according to any one of claim 11, and further comprising storing the write requests in a first buffer and storing the read requests in a second buffer.

13. A method according to claim 8, wherein the step of executing the decision logic in response to the detection of a stalled read request, comprises accessing a minimum packet size and outputting a decision to process the same read request if data acquired prior to the stalling is below the minimum packet size.

14. A method according to claim to 13, wherein the step of executing the decision logic in response to the detection of a stalled read request, comprises accessing a predefined message size and outputting a decision to process the same read request if data acquired prior to the stalling is not an integer multiple of the predefined message size.
